(19) United States
(12) Patent Application Publication
(10) Pub. No.: US 2018/0069836 A1
(43) Pub. Date: Mar. 8, 2018

(54) TIERED ATTESTATION FOR RESOURCE-LIMITED DEVICES

(71) Applicant: QUALCOMM Incorporated, San Diego, CA (US)

(72) Inventor: Giridhar Dhati Mandyam, San Diego, CA (US)

(21) Appl. No.: 15/430,075

(22) Filed: Feb. 10, 2017

Related U.S. Application Data
(60) Provisional application No. 62/383,343, filed on Sep. 2, 2016.

(51) Int. Cl. H04L 29/06

(52) U.S. Cl. CPC H04L 63/0281; H04L 63/0853

(57) ABSTRACT

A method operational at a gateway device is provided to facilitate attestation of client devices by an attestation recipient device. The gateway device may obtain attestation metadata from a metadata service. It may then receive a transaction request from a client device. The client device attestation information may be verified by the gateway device against the obtained attestation metadata. The gateway device may then generate a gateway device attestation information and sends the transaction request to a recipient device along with the gateway device attestation information. The gateway device attestation information serves to at least partially vouch for the client device. The gateway may then receive a confirmation for the transaction request and forwards the confirmation for the transaction request to the client device.

### CROSS-REFERENCE TO RELATED APPLICATIONS

This application claims the benefit of U.S. Provisional Application Ser. No. 62/383,343 filed in the U.S. Patent Office on Sep. 2, 2016, the entire content of these applications being incorporated herein by reference and for all applicable purposes.

### FIELD

The present application is related to methods for establishing security and/or performing authentication between devices, and more specifically to ways of performing attestation by internet-o-things (IoT) devices with assistance of intermediary/gateway devices.

### BACKGROUND

As part of establishing trust between devices (e.g., in order to establish communications and/or certify data being sent, etc.), authentication and/or authorization procedures are often performed between such devices. Generally, the goal is to permit a receiving device to ascertain a trustworthiness of a sending device and/or data received from such sending device. Device attestation statements are often part of an authentication process for many security-related applications.

A receiving device (e.g., relying party) may leverage an attestation statement along with a trusted source of attestation metadata to authenticate a sending device or the data received. Attestation metadata can include: (a) a public certificate for the sending device, and (b) device characteristics (e.g. how a private key is secured by the sending device). An example of a trusted source is the Fast Identity Online (FIDO) Alliance Metadata Service.

Internet-of-Things (IoT) devices (aka, IoE devices or Internet of Everything devices) often have limited communication resources, limited processing capabilities/resources, and/or limited power. For instance, some IoT devices may lack connectivity (e.g., direct access to an external communication network or internet) and may rely on an external gateway for communications. Likewise, some IoT devices may not be capable of providing attestation directly, and may have to rely on the external gateway for attestation assistance.

Consequently, there is a need for a method for IoT devices to provide attestation as part of an authentication process.

### SUMMARY

A first aspect provides a method operational at a gateway device to facilitate tiered attestation. Attestation metadata is obtained ((by the gateway device) from a metadata service. A transaction request may be received from a client device. The gateway device may generate a gateway device attestation information. The transaction request is then sent to a recipient device along with the gateway device attestation information, where the gateway device attestation information at least partially vouches for the client device. A confirmation for the transaction request may be received by the gateway device. This confirmation may then be forwarded for the transaction request to the client device. The gateway device attestation information may serve to independently authenticate the gateway device and/or a relationship with the client device. In some implementations, the client device may be an internet-of-things (IoT) device having only short range communication capabilities relative to the gateway device. The gateway device may communicates with the client device over a short range communication interface and communicates with the recipient device over a long range communication interface.

In one example, the transaction request includes attestation information for the client device, and the gateway may further verify the client device attestation information against the obtained attestation metadata. The transaction request may also include the client device attestation information if it is successfully verified by the gateway device. The transaction request may only be sent if the client device attestation information is successfully verified by the gateway device. The client device attestation information may serve to independently authenticate the client device.

A second aspect provides a gateway device, comprising a local communication circuit, a network communication circuit, and a processing circuit. The local communication circuit may be configured to communicate with one or more client devices. The network communication circuit may be configured to communicate with one or more recipient devices. The processing circuit may be configured to: (a) obtain attestation metadata from a metadata service, (b) receive a transaction request from a client device, (c) generate a gateway device attestation information, (d) send the transaction request to a recipient device along with the gateway device attestation information, where the gateway device attestation information at least partially vouches for the client device, (e) receive a confirmation for the transaction request, (f) forward the confirmation for the transaction request to the client device.

In one implementation, the transaction request may include attestation information for the client device, and the processing circuit is further configured to: verify the client device attestation information against the obtained attestation metadata. In some instances, the transaction request may also include the client device attestation information if such client device attestation information is successfully verified by the gateway device. In other instances, the transaction request may only be sent if the client device attestation information is successfully verified by the gateway device. The client device attestation information may serve to independently authenticate the client device. The gateway device attestation information may serve to independently authenticate the gateway device and/or a relationship with the client device.

Another aspect provides a non-transitory machine-readable storage medium having one or more instructions stored thereon, which when executed by at least one processor causes the at least one processor to: (a) obtain attestation metadata from a metadata service; (b) receive a transaction request from a client device; (c) generate a gateway device attestation information; (d) send the transaction request to a recipient device along with the gateway device attestation information, where the gateway device attestation information at least partially vouches for the client device, (e) receive a confirmation for the transaction request; and/or (f) forward the confirmation for the transaction request to the client device.

### BRIEF DESCRIPTION OF THE DRAWINGS

FIG. 1 illustrates an exemplary operating environment in which a client device (e.g., IoT device) may rely on a gateway to provide attestation on its behalf to a recipient device.

FIG. 2 illustrates exemplary attestation transactions between client (IoT) devices, a gateway, and a recipient device.

FIG. 3 illustrates an exemplary gateway device that may be configured to facilitate attestation by another (recipient) device.

FIG. 4 illustrates an exemplary method that may be implemented by a gateway device to facilitate attestation by another (recipient) device.

### DETAILED DESCRIPTION

In the following description, specific details are given to provide a thorough understanding of the aspects described herein. However, it will be understood by one of ordinary skill in the art that the aspects may be practiced without these specific details. For example, circuits may be shown in block diagrams in order avoid obscuring aspects in unnecessary detail. In other instances, well-known circuits, structures, and techniques may not be shown in detail in order not to obscure the aspects more fully described herein.

The word “exemplary” is used herein to mean “serving as an example, instance, or illustration.” Any implementation or aspect described herein as “exemplary” is not necessarily to be construed as preferred or advantageous over other implementations or aspects. The term “aspect” does not require that all aspects include the discussed aspect, or any discussed feature, advantage, and/or mode of operation.

### Overview

A first aspect provides a way for devices with limited resources to provide attestation information as to other devices by relying on an intermediate gateway. As used herein “attestation”, “attestation statement”, and/or “attestation information” may be interchangeably used to refer to information that can be used to: (a) authenticate a device, (b) confirm the normal operation of the device, and/or (c) confirm one or more characteristics (e.g., security level/profile, hardware profile, etc.) of the device. For devices that are capable of providing attestation information (e.g., devices having built-in attestation capabilities), such devices may provide their attestation information to a nearby gateway. The gateway may have obtained attestation metadata from a third party metadata service and is able to verify the device attestation information. The gateway may also append its own attestation information and sends both the device attestation information and gateway attestation information to a recipient device (e.g., relying device) for verification/authentication. The recipient device may be able to authenticate both the device attestation information and the gateway attestation information in order to ascertain whether the device is successfully authenticated. That is, the recipient device may rely, at least partially, on the gateway information vouching for the device as part of the authentication of the device.

For devices that are not capable of providing attestation information (e.g., no built-in attestation capabilities), such devices may simply send unattested transaction requests via the gateway. In such case, the gateway may append its own attestation information and sends the gateway attestation information to the recipient device (e.g., relying device) for verification/authentication. The recipient device may be able to authenticate the gateway attestation information in order to ascertain whether the device is successfully authenticated. That is, the recipient device may rely on the gateway information vouching for the device as part of the authentication of the device.

Exemplary Network with Separate Service Context and Connectivity Context

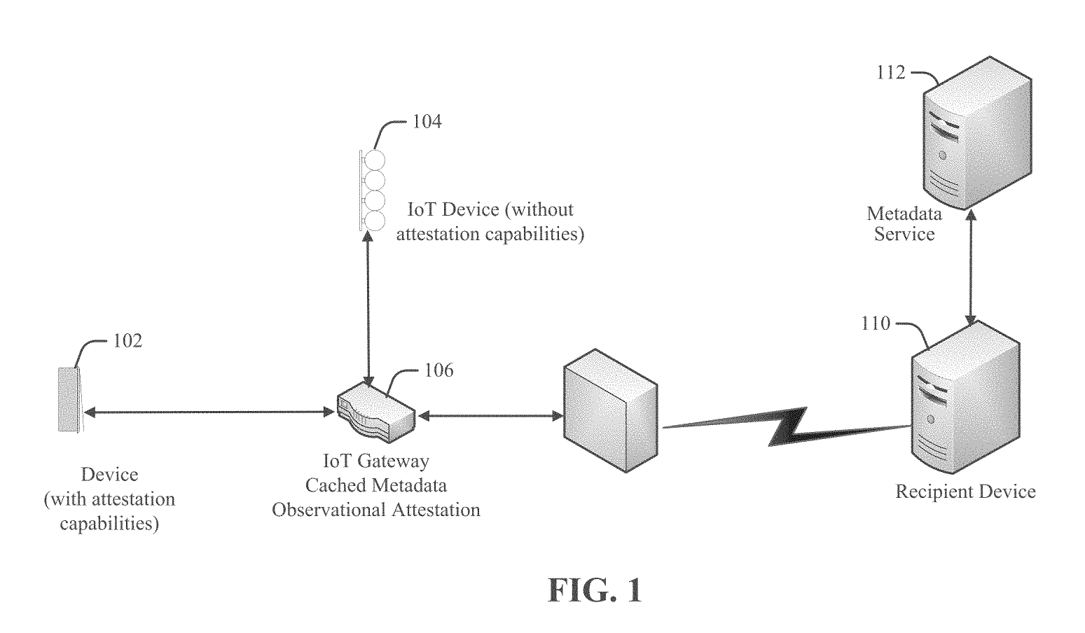

FIG. 1 illustrates an exemplary operating environment in which a device 102 or 104 (e.g., IoT device) may rely on a gateway 108 to provide attestation on its behalf to a recipient device 110. In this example, the gateway 106 (e.g., IoT gateway) may be configured to attest on behalf of a device 102 or 104 if that device cannot attest for itself. For instance, the gateway 106 may monitor the behavior of the device 102 or 104 (e.g., traffic patterns for the device) and apply attestation accordingly. In one example, the gateway 106 may rely on cached metadata to verify attestation statements from the device 102 or 104 as well. The gateway 106 may also attests for itself for any receiving device 110 (e.g., relying party).

In some implementations, an IoT device may have limited communication and/or computational resources, preventing it from, for example, performing cryptographic operations and/or generating cryptographic signatures. In such cases, attestation is the next best option. In attestation, an IoT device simply provides some information (either directly or implicitly) that confirms whether it is operating correctly (e.g., it has not been compromised or hacked, or it is operating securely) or confirms some information about the attesting IoT device.

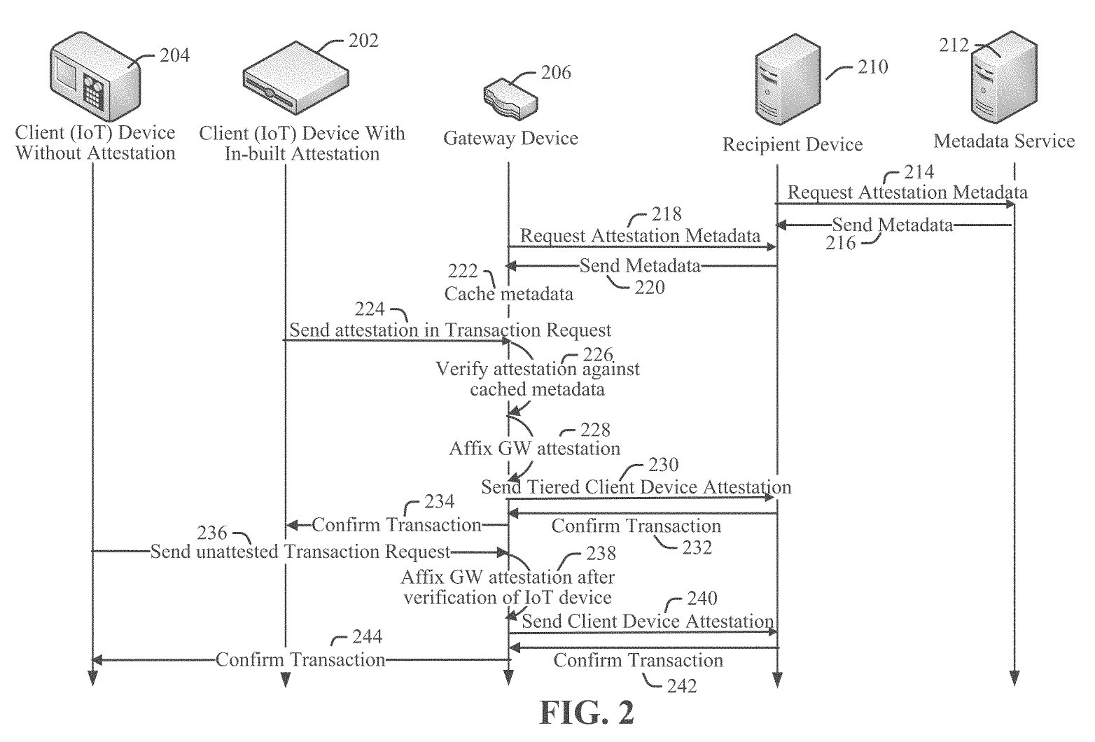

FIG. 2 illustrates exemplary attestation transactions between client (e.g., IoT) devices 202 and 204, a gateway 206, and a recipient device 210. Initially, the recipient device 210 may request attestation metadata 214 from a metadata service node 212. The metadata service node 212 may have collected such attestation metadata beforehand (e.g., at manufacturing of the client devices) and sends the attestation metadata 216. The gateway 206 may request attestation metadata 218 from the recipient device 210, receives such attestation metadata 220, and caches the attestation metadata 222.

A first client device 202 with built-in attestation capabilities may send attestation in a transaction request 224 to the gateway 206. Upon receipt, the gateway 206 may verify the first device's attestation against the previously received cached attestation metadata 226. Upon successful verification, the gateway 206 may affix/append its own gateway attestation 228 and sends a tiered client attestation 230 to the recipient device 210. The recipient device 210 may use both the first client device attestation and gateway attestation to confirm authenticity and confirms the transaction 232 to the gateway 206. The gateway 206 in turn may confirm the transaction 234 to the first client device 202.

A second client device 204 without attestation capabilities may send an unattested transaction request 236 to the gateway 206. Upon receipt, the gateway 206 may affix/append its own gateway attestation 238 after verification of the second client device 204 and sends a client device attestation 240 to the recipient device 210. The recipient device 210 may use the gateway attestation to authenticate and confirms the transaction 242 to the gateway 206. The gateway 206 in turn may confirm the transaction 244 to the second client device 204.

In this manner, client (IoT) devices with and without attestation capabilities may be capable of performing attestation transactions by relying on the gateway 206.

An exemplary tiered attestation for a gateway may include various parameters/data, including:

```
Interface attestation {
        readonly DOMString GWGUID; //ID of IoT Gateway (GW)
        readonly DOMString type; // Packed attestation, JSON Web
        Token etc.
        readonly DOMString GWAttestation; //Gateway attestation
        statement
        readonly DOMString publicKey; //GW public key
        readonly DOMString alg; //Signing algorithm
        readonly DOMString signature;//Signature over attestation data
        readonly DOMString cert;//X.509 cert used for attestation sig
        readonly DOMString[ ] IoTAttestationData;//Array of IoT
        attestation data
        readonly DOMString[ ] IoTGUID;//Array of ID's of
        GW-attested devices
        }
```

Information fields can also be included in other types of token representation, e.g. JSON Web Token (RFC 7519) and/or CBOR Web Token (IETF draft-ietf-ace-cbor-web-token-01).

An exemplary JSON Web Token Example (RFC 7519 compliant) may include:
JWT Header={“alg”: “HS256”, “typ”: “JWT”}
   HMAC SHA-256 used for creation of signature
JWT Payload={“GWGUID”: “ . . . ”, “attType”: “ . . . ”, “publicKey”: “ . . . ”, “IoTAttestationData”: [{“attData”: “ . . . ”}], “IoTGUID”: [{“GUID”: “ . . . ”}]}
   Serialized JSON format of WebIDL object (see slide 5)
Signature (as per standard)=HMACSHA256(base64URLencode(Header)+“.”+base64URLencode(Payload), key)
Final JWT: base64URLencode(Header).base64URLencode(Payload).Signature

### Exemplary Gateway Device and Attestation Method

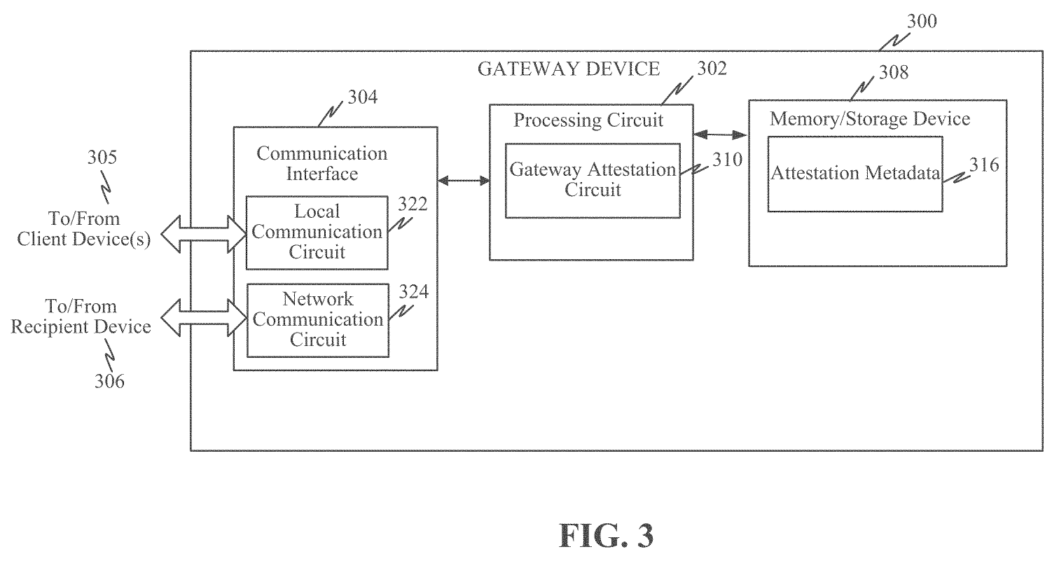

FIG. 3 illustrates an exemplary gateway device 300 that may be configured to facilitate attestation by another (recipient) device. The gateway device 300 may include a processing circuit 302, a communication interface 304, and a memory/storage device 308. The communication interface 304 may include a local communication circuit 322 that may serve to provide communications to/from nearby devices (e.g., client devices or IoT devices), and a network communication circuit 324 to communicate, for instance, with a recipient (relying) device. The processing circuit 302 may include a gateway attestation circuit 310 that provides attestation information on behalf of the gateway and/or client devices served by the gateway device. Additionally, the memory/storage device 308 may serve to store attestation metadata 316 that the gateway may have obtained from a third party and which can be used to authenticate client device attestation information.

In one example, the client (IoT) devices served by the gateway device 300 may have limited communication resources and/or limited attestation resources. For instance, the local communication circuit 322 may serve to communicate within a short range (e.g., within 1, 5, 10, 25, 50, or 100 meters) via a wired or wireless medium. In one example, such short range communications may use a wireless Bluetooth communication protocol. By contrast, the network communication circuit 324 may serve to communicate over longer ranges/distances over a wireless or wired medium. In various examples, the network communication circuit 324 may serve to communicate over the Internet, a wireless mobile telephony network, and/or other digital communication networks.

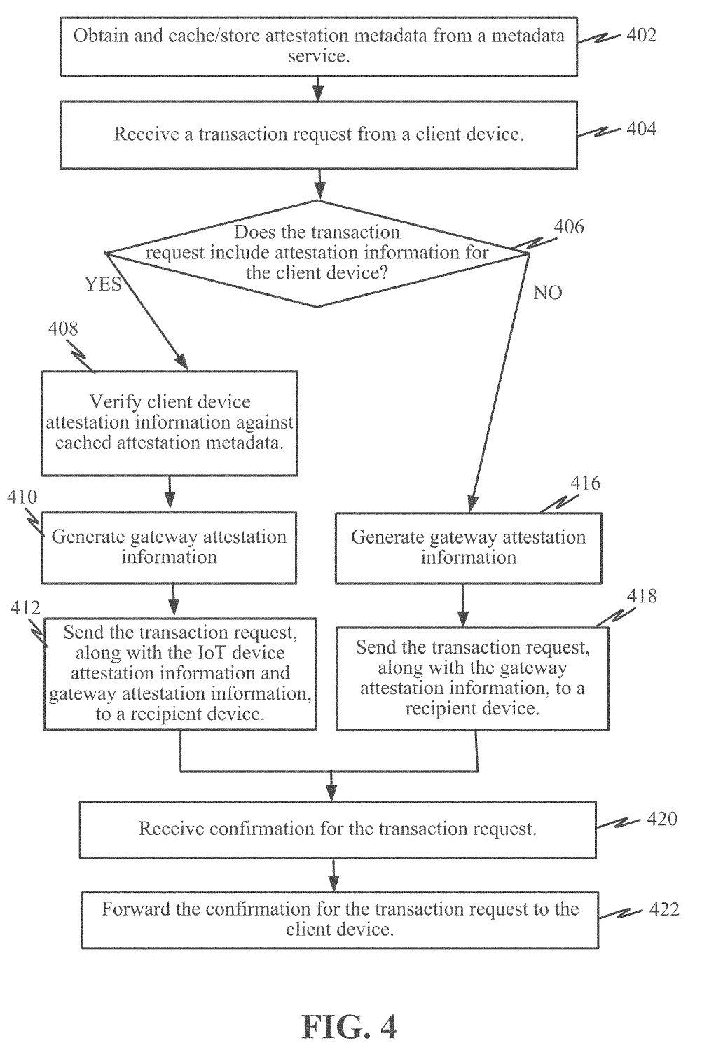

FIG. 4 illustrates an exemplary method that may be implemented by a gateway device to facilitate attestation by another (recipient) device. The gateway device may obtain and cache/store attestation metadata from a (third party) metadata service 402. For instance, such attestation metadata may serve to authenticate (at least partially) another device.

The gateway device may receive a transaction request from a client device 404 (e.g., IoT device). Such transaction request may include, for example, a registration of the IoT device, a cryptographic operation/exchange between the client device and another device, or some other transaction involving the client device.

If the transaction request includes attestation information for the client device 406, then the gateway device can verify client device attestation information against the cached attestation metadata 408. For instance, the client device attestation information may have been obtain during manufacturing or installation of the client device as stored by the metadata service for subsequent distribution.

The gateway device may also generate gateway attestation information 410. That is, if the gateway device successfully verifies the attestation information for the client device, then it may generate/obtain/append the gateway attestation information. In some examples, the gateway device may have sufficient resources to generate cryptographic signatures; consequently, the gateway attestation information may be generated using a cryptographic operation (e.g., using a private key for the gateway device). The transaction request, along with the client device attestation information and gateway attestation information, may then be sent by the gateway device to a recipient device 412.

If the transaction request does not include attestation information for the client device 406, then the gateway device may generate gateway attestation information 416. That is, the gateway device may ascertain (e.g., through signalling or monitoring of the client device communications), that the client device is operating correctly and generates/obtains/appends the gateway attestation information as a way to vouch for the client device. The transaction request, along with the gateway attestation information, may then be sent by the gateway device to a recipient device 418.

In response to sending the transaction request, the gateway device may receive confirmation of the transaction 420. The confirmation for the transaction request may then be forwarded to the client device 422.

One or more of the components, steps, aspects, and/or functions illustrated in the figures may be rearranged and/or combined into a single component, step, aspect, or function or embodied in several components, steps, or functions. Additional elements, components, steps, and/or functions may also be added without departing from novel aspects disclosed herein. The apparatus, devices, and/or components illustrated in the figures may be configured to perform one or more of the methods, aspects, or steps described in the figures. The novel algorithms described herein may also be efficiently implemented in software and/or embedded in hardware.

Also, it is noted that the examples may be described as a process depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines, and/or devices.

Furthermore, examples may be implemented by hardware, software, firmware, middleware, microcode, or any combination thereof. When implemented in software, firmware, middleware, or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the examples disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various aspects of the examples described herein can be implemented in different systems without departing from the scope of the disclosure. It should be noted that the foregoing examples are merely examples and are not to be construed as limiting. The description of the examples is intended to be illustrative, and not to limit the scope of the claims. As such, the present teachings can be readily applied to other types of apparatuses and many alternatives, modifications, and variations will be apparent to those skilled in the art.

What is claimed is:

1. A method operational at a gateway device, comprising
obtaining attestation metadata from a metadata service;
receiving a transaction request from a client device;
generating a gateway device attestation information; and
sending the transaction request to a recipient device along with the gateway device attestation information, where the gateway device attestation information at least partially vouches for the client device.

2. The method of claim 1, further comprising:
receiving a confirmation for the transaction request.

3. The method of claim 2, further comprising:
forwarding the confirmation for the transaction request to the client device.

4. The method of claim 1, wherein the transaction request includes client device attestation information for the client device, and further comprising:
verifying the client device attestation information against the obtained attestation metadata.

5. The method of claim 4, wherein the transaction request also includes the client device attestation information if it is successfully verified by the gateway device.

6. The method of claim 4, wherein the transaction request is only sent if the client device attestation information is successfully verified by the gateway device.

7. The method of claim 4, wherein the client device attestation information serves to independently authenticate the client device.

8. The method of claim 1, wherein the gateway device attestation information serves to independently authenticate the gateway device and/or a relationship with the client device.

9. The method of claim 1, wherein the client device is an internet-of-things (IoT) device having only short range communication capabilities relative to the gateway device.

10. The method of claim 1, wherein the gateway device communicates with the client device over a short range communication interface and communicates with the recipient device over a long range communication interface.

11. A gateway device, comprising:
a local communication circuit to communicate with one or more client devices;
a network communication circuit to communicate with one or more recipient devices;
a processing circuit coupled to the local communication circuit and the network communication circuit, the processing circuit configured to:
obtain attestation metadata from a metadata service,
receive a transaction request from a client device,
generate a gateway device attestation information, and
send the transaction request to a recipient device along with the gateway device attestation information, where the gateway device attestation information at least partially vouches for the client device.

12. The gateway device of claim 11, wherein the processing circuit is further configured to:
receive a confirmation for the transaction request.

13. The gateway device of claim 12, further comprising:
forward the confirmation for the transaction request to the client device.

14. The gateway device of claim 11, wherein the transaction request includes client device attestation information for the client device, and the processing circuit is further configured to:
verify the client device attestation information against the obtained attestation metadata.

15. The gateway device of claim 14, wherein the transaction request also includes the client device attestation information if such client device attestation information is successfully verified by the gateway device.

16. The gateway device of claim 14, wherein the transaction request is only sent if the client device attestation information is successfully verified by the gateway device.

17. The gateway device of claim 14, wherein the client device attestation information serves to independently authenticate the client device.

18. The gateway device of claim 11, wherein the gateway device attestation information serves to independently authenticate the gateway device and/or a relationship with the client device.

19. A non-transitory machine-readable storage medium having one or more instructions stored thereon, which when executed by at least one processor causes the at least one processor to:
obtain attestation metadata from a metadata service;
receive a transaction request from a client device;
generate a gateway device attestation information; and
send the transaction request to a recipient device along with the gateway device attestation information, where the gateway device attestation information at least partially vouches for the client device.

20. The non-transitory machine-readable storage medium of claim 19, further having one or more instructions stored thereon, which when executed by the at least one processor causes the at least one processor to:
receive a confirmation for the transaction request; and
forward the confirmation for the transaction request to the client device.
